(19) United States
(12) Patent Application Publication
(10) Pub. No.: US 2011/0105716 A1
(43) Pub. Date: May 5, 2011

(54) PROCESS AND APPARATUS FOR PREPARING BIOPOLYMERS

(76) Inventors: Bernhard Stuetzle, Riedisheim (FR); Pierre-Alain Fleury, Ramlinsburg (CH)

(21) Appl. No.: 12/993,676

(22) PCT Filed: May 20, 2009
(86) PCT No.: PCT/EP2009/003608

§ 371 Date: Dec. 30, 2010

(30) Foreign Application Priority Data
May 22, 2008 (DE) 10 2008 024 721.9
Jun. 20, 2008 (CH) 00948/08

(51) Int. Cl. C08G 63/08; C08G 63/06; B01J 19/18

(52) U.S. Cl. 528/354; 528/361; 422/135; 422/119

(57) ABSTRACT

In a method of treating viscous products, particularly for the implementation of polymerization operations, more particularly for the homopolymerization or copolymerization of bipolymers, where monomer(s) and/or catalysts and/or initiators are fed to a backmixed mixing compound (1), in particular having a length/diameter ratio of 0.5-3.5, more particularly a process corresponding to a stirred tank cascade of 2-5 stirred tanks in series, and the product is supplied with heat and is backmixed with product that has already reacted, and the reacted product is taken off from the mixing compound (1), the product is to be heated in the mixing compound (1) up to its optimum processing temperature or boiling temperature or sublimation temperature, parts of the product are to be evaporated, and hence the exothermic heat of the product and excess mechanical introduction of heat are absorbed by evaporative cooling.

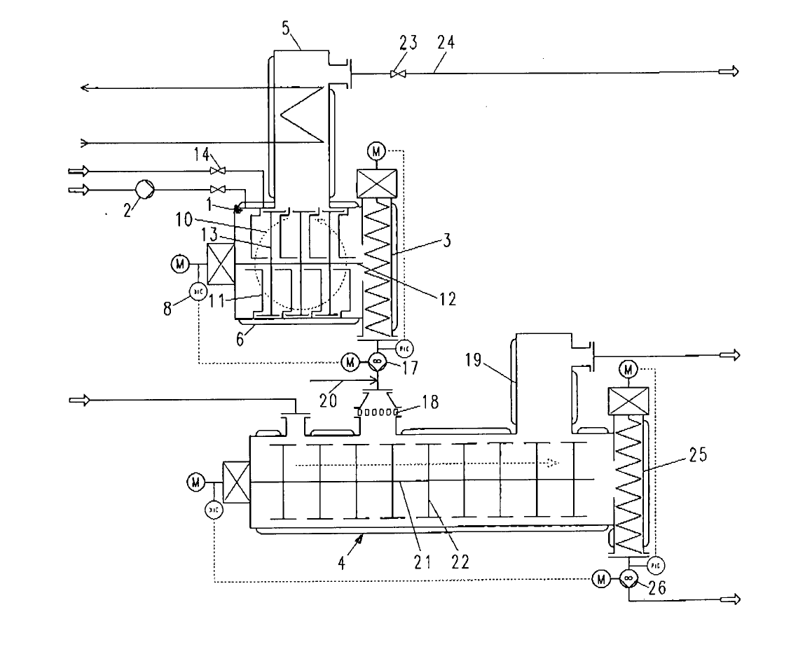

### BACKGROUND OF THE INVENTION

The invention relates to a process for preparing biopolymers, especially for performing polymerization processes, especially for homo- or copolymerizing biopolymers, by adding monomer(s) and/or catalysts and/or initiators to a backmixed mixing kneader, especially having a length/diameter ratio of 0.5-3.5, supplying heat to the product and backmixing with already reacted product, and removing the reacted product from the mixing kneader, and to an apparatus therefor. The invention also relates to two-stage processes which combine polymerization processes with a downstream degassing/demonomerization/devolatilization stage.

A considerable portion of polymerization reactions, especially for preparation of homo- and copolymeric biopolymers, for example PLA (polylactic acid), PHB (polyhydroxybutyrate), PHA (polyhydroxyalkanoate), polydextrose, bio-PET, starch, cellulose, chitins and proteins, are performed commercially as slurry or solution processes in one or more series-connected, continuously operated, backmixed, vertical stirred tank reactors, known as “CSTRs”, continuous stirred tank reactors.

These stirred tank reactors have the task of very substantially homogeneously distributing the monomers, the catalysts and initiators in a solvent/diluent under exactly defined process conditions, such as temperature and pressure, such that the reaction proceeds in a controlled manner, a homogeneous product quality with the desired molar mass is obtained and the heat of reaction is also controlled. The problem with these stirred tank reactors is that only products with a low apparent viscosity or melt viscosity can be processed.

As the concentration of the polymer in the solvent/diluent rises, the apparent viscosity of the reaction mixture rises to such a degree that the stirrer ultimately cannot generate sufficient convective flow. The consequence of this is inhomogeneous distribution of the monomers. This leads to lump formation, poor molar mass distribution, caking, and local overheating up to and including uncontrollable reaction of the entire reactor contents.

A further problem with stirred tank reactors in the case of individual products is foam formation or significant inflation of the product mixture, which can lead to blockages and occlusions at the dome outlets.

The result of the abovementioned processing risks is that stirred tank reactors are operated with a large excess of solvent/diluent up to approx. 90% of the reaction mixture, or only limited conversions can be achieved in the case of bulk polymerizations, often only of less than 50%, owing to high viscosities. As a consequence, additional process steps are necessary for mechanical/thermal removal of the diluents or of the solvent/monomer, or for postreaction (increase in the chemical conversion).

This is generally accomplished in dewatering screws, evaporation and drying systems, and maturing tanks. They mean high capital, energy and operating costs. There are also new polymers which are not processible by a water stripping process.

Bulk polymerizations or copolymerizations are also performed continuously in single-shaft or multishaft extruders (for example from Werner-Pfleiderer, Buss-Kneter, Welding Engineers, etc.). These apparatuses are designed for polymerizations in the viscous phase up to high conversions. They are constructed as continuous plug flow reactors and accordingly have a large L/D ratio of >5 to approx. 40.

The following problems occur here:

a) In the case of slow polymer reactions with reaction times of >5 minutes, in which the reaction mixture remains in the liquid state for a long time, plug flow cannot be maintained. The very different rheological properties between the monomers and polymers prevent homogeneous product transport, which leads to undesirable fluctuations in quality.

b) The high exothermicity of many polymerization processes and the mechanically dissipated kneading energy frequently necessitate effective and efficient removal of these energies by means of evaporative cooling. In this case, a portion of the monomer or of the added solvent/diluent is evaporated and condensed in an external condenser, and the condensate is recycled into the reactor. Owing to the large L/D ratio and the large screw cross section which is a result of the construction, only very limited free cross-sectional areas are available for the withdrawal of vapors. This leads to the undesired entrainment of polymers into the dome outlets, the vapor lines or/and into the reflux condenser, and, as a consequence thereof, to blockages/occlusions.

c) In the case of preparation of (co-)polymers from several different monomers, an additional complicating factor is that mainly the monomer with the lowest boiling point evaporates for the evaporative cooling, such that a shift in the monomer concentrations is established in the reactor, more particularly in the region of the entry orifice of the condensate reflux. This is generally undesirable.

d) Another disadvantage is that the free product volume of screws is limited to about 1.5 m³ for reasons relating to mechanical construction, such that only low throughputs can be achieved in the case of reactions with residence times of >5 minutes, which in turn entails the installation of several parallel lines with correspondingly high capital and operating costs.

A further means of performing bulk polymerizations up to high conversions is described in U.S. Pat. No. 5,372,418. Here, co- or counter-rotating twin-screw extruders with non-meshing screws or screw pairs which convey in opposite directions are described for polymerization of the monomers by backmixing with the polymer in the viscous phase. These apparatuses are in principle capable of performing polymerization processes up to high conversions and at the same time of avoiding the above-described disadvantages a) (collapse of plug flow) and c) (shift in formulation as a result of reflux) of the plug flow extruder. However, the above-described problems b) (reduced free cross section) and d) (capacity) still remain unsolved.

The abovementioned processes are also carried out in what are known as mixing kneaders, in which the product is transported by appropriate kneading and transport elements from an inlet to an outlet, and at the same time is subjected to intense contact with the heat exchange surfaces. Such mixing kneaders are described, for example, in DE-C 23 49 106, EP 0 517 068 A1 and DE 195 36 944 A1.

It is an object of the present invention to perform the abovementioned process in concentrated, relatively high-viscosity phase, to optimize the corresponding apparatus to that effect, and in particular also to accelerate the process steps and to increase the product quality, or to widen the product range.

### SUMMARY OF THE INVENTION

The object is achieved firstly by heating the product in the mixing kneader up to a particular processing temperature at which portions of the product evaporate under the controlled operating pressure which exists (elevated pressure, atmospheric or reduced pressure), and hence the exothermicity of the reaction mixture and also the kneading energy dissipated in the viscous reaction mixture are absorbed effectively and efficiently by evaporative cooling. The operating conditions (heating temperature, operating pressure, mixing kneader fill level, kneader shaft speed, etc.) are selected such that, whenever possible, a virtually exact energy balance is achieved, which then allows an advantageous extrapolation of the process singly and solely to the residence time required for the process to be performed. The evaporated product(s) is/are condensed and recycled into the reaction mixture in a controlled manner (reflux condensation).

Since the wetted product surface area is significantly greater than the apparatus contact area of the mixing kneader, the condensate can be distributed as a film over the entire surface area of the product, thus contributing to efficient and homogeneous cooling action. The gas space of the mixing kneader, which is open over the entire process space length, allows the evaporation of the monomer(s) and the controlled recycling of the condensate, preferably into the feed region and/or the region with high reactivity.

According to the product, the optimal processing temperature is set by an adjustment of the operating pressure which exists in the mixing kneader.

In a further working example of the process, for which separate protection is sought but can be performed particularly effectively in connection with the process just described, the product should be backmixed until a predetermined viscosity of the product is attained, and this viscosity should be maintained by continuously adding further monomer and/or catalysts and/or initiators.

A low viscosity indicates to the user of a corresponding mixing kneader that only or essentially monomer of low viscosity is present in the mixing kneader. The more the polymerization advances, the more the viscosity of the reaction mixture increases. When a predetermined viscosity of the product has been attained, this is a signal that a particular percentage of the product has now been converted to polymer. This is a signal to operate the mixing kneader in the continuous process, specifically in such a way that the viscosity and hence the conversion or degree of polymerization remain the same. This is essentially determined by the kneader shaft torque which, given constant mixing kneader filling, is a function of the viscosity of the reaction mixture, and/or by the product temperature profile over the process space length of the mixing kneader.

### Example 1

PLA (polylactic acid) can be prepared by a “ring-opening” polymerization, for example, in a mixing kneader within an optimal processing temperature range of 175 to 1900° C., under an inert atmosphere, slightly elevated pressure of nitrogen or an operating vacuum of 40-100 mbar abs., by adding the lactide monomer and the catalyst solution.

Below this optimal temperature range, the viscosity of the PLA formed increases dramatically, as a result of which the kneader shaft torque rises significantly and heat of mechanical kneading is increasingly dissipated into the reaction mixture. Above the optimal temperature range, there is a risk, increasing with temperature and residence time, of thermal product damage and/or depolymerization.

Operation under slightly elevated nitrogen pressure has the advantage of ruling out the possibility of the uncontrolled introduction of atmospheric oxygen or atmospheric moisture, which is harmful to the reaction system; operating under reduced pressure has the advantage of higher cooling action as a result of enhanced evaporating action.

The monomer stream of lactide (and the catalyst solution micromixed therein in very small amounts) is fed continuously to the mixing kneader in the molten state at temperatures above 115° C. The molten lactide stream is micromixed with the catalyst solution typically using static mixers or “tube-in-tube mixers”, just upstream of entry into the mixing kneader. Micromixing is a prerequisite for optimal reactivity and homogeneous product quality, and for a stable process regime. The micromixed feed stream is mixed immediately into the relatively high-viscosity reaction mixture which has already been partly converted in the feed region and is present in the mixing kneader, at customary product temperatures around 175-180° C. The feed stream thus finds ideal conditions and reaction temperatures above 140° C. in the mixing kneader from the start, which allow spontaneous starting of the reaction and the most rapid possible conversion to PLA.

The exothermicity of the polymerization reaction and the mechanical kneading energy dissipated in the form of heat cover the heating of the feed stream. Excess heat is effectively removed via evaporative cooling (evaporation and reflux condensation of the lactide monomer), in order to achieve the energy balance. The heat transfer to the product via the heat carrier oil at approx. 175-190° C. or steam-heated contact surfaces of the mixing kneader is negligible in the energy balance owing to the small temperature differences of product/reaction mixture and heating medium. Heat transfer is of significance only during startup phases, unless the required process heat can be introduced via the mechanical kneader output because the viscosities are too low.

The product temperature profile in the mixing kneader, as a function of freely selectable parameters such as operating pressure, stirrer shaft speed, fill level and product throughput (monomer and catalyst solution), can be set ideally to values of 175-180° C. at the inlet and 180-190° C. at the outlet. This rising product temperature profile reflects rising viscosity and rising conversion to PLA in the mixing kneader toward the outlet. This makes it clear that the mixing kneader is not a system with ideal backmixing, but that the behavior corresponds to that of a stirred tank cascade with about 3-5 series-connected stirred tanks.

The conversion rates reach up to about 90-96% PLA with narrow molar mass distribution (polydispersity approx. 2). The required residence times in the mixing kneader are 20 to 50 min according to the desired molar mass and catalyst solution concentration.

### Example 2

The same apparatus and process regime with appropriately adjusted parameters is also an option in the case of preparation of PLA from the lactic acid monomer via the polycondensation reaction.

This process according to the invention achieves the advantage of also being able to efficiently and reliably process high to very high melt viscosities, and hence of being able to achieve, for example in the case of polymerization reactions, high conversion rates in one step and in a single mixing kneader. During the process with viscous mixtures, any phenomena such as extreme foam formation and/or extreme inflation of the viscous product mixture which occur are effectively suppressed by virtue of very good interface renewal rates in the mixing kneader.

In the mixing kneader, as well as polymerization reactions, it is also possible to efficiently perform the evaporative concentration of polymer solutions. The evaporation energy required to evaporate large amounts of solvents is accordingly maximized by the combination of contact heat and in particular high mechanically dissipated kneader heat (shear). The possibility of keeping the product temperature constant or imposing an upper limit thereon via the evaporation of solvents or monomers allows a high degree of freedom in relation to the regulation of the mechanical kneader heat via the speed (shear gradient) and the fill level of the mixing kneader.

If, in a preferred working example, a second mixing kneader, extruder, flash pot or the like should be arranged downstream, degassing or demonomerization/devolatilization also takes place therein. For example, in such a second mixing kneader or extruder, the product can be subjected to plug flow by virtue of appropriate geometry of the kneading elements. In this second process step, residual evaporative concentration takes place, which is often limited by mass transfer, down to very low residual contents of solvents and/or monomers, and preference is therefore given here to using twin-shaft mixing kneaders which are described in the prior art. Flash pots may be suitable especially for products with which degassing or demonomerization/devolatilization takes place spontaneously and rapidly and which still have sufficient free flow in order, for example, to feed a gear pump below for a subsequent granulation.

For mixing kneaders with the plug flow feature, it is essential that the surface/interface of the product is renewed as rapidly as possible, since the liquid evaporates from this surface. Since the evaporation sites withdraw further and further into the material interior, the product surface has to be renewed permanently by more intense kneading. In addition, good product temperature control is necessary.

The desire for the provision of the greatest possible product/gas interfaces can in particular also be taken into account by dividing or comminuting the product before entry into the second mixing kneader/extruder/flash pot, which is accomplished, for example, by a corresponding perforated plate or a nozzle with a high number of nozzle holes. When the product, after discharge from the first mixing kneader, is forced through a perforated plate, for example by means of a gear pump, it passes in strands (in the manner of spaghetti) into the second mixing kneader/extruder/flash pot. The second mixing kneader/extruder/flash pot is preferably run under high vacuum and maximum product temperature.

The discharge of the viscous polymer material is accomplished by means of a twin screw with forced conveying which is integrated into the mixing kneader and is positioned horizontally or vertically. This double screw in turn feeds a gear pump connected directly downstream, the speed of which can be regulated such that the fill level and hence the product residence time in the mixing kneader remain constant. The product is supplied to the gear pump with the feed pressure kept constant by means of speed regulation of the twin screw.

The regulating parameter used for the speed regulation of the gear pump is the torque of the mixing kneader shaft.

### Example

To demonomerize the PLA material with a residual content of 4-10% monomeric lactide formed in the first mixing kneader, this material is supplied by means of gear pumps via perforated plates and/or suitably configured nozzles to a second mixing kneader/extruder/flash pot, which is ideally operated under a reduced pressure of <50-10 mbar abs., or even better under a high vacuum of <10-0.5 mbar abs. This is ideally done at a maximum permissible product temperature of 190-210° C. The residence time should be kept as short as possible in order to prevent product damage and/or “chemical reformation” of lactide monomer.

### BRIEF DESCRIPTION OF THE DRAWINGS

Further advantages, features and details of the invention are evident from the description of a preferred working example which follows, and from the drawing: this shows, in its sole FIGURE, a schematic diagram of an inventive plant for treating viscous products, especially for performing polymerization reactions and subsequent degassing, demonomerization and devolatilization processes.

### DETAILED DESCRIPTION

In a single-shaft or twin-shaft mixing kneader 1 which is surrounded by a heating jacket 6, has backmixing stirrer shaft geometry and is filled with partly reacted product, monomer(s), catalysts, initiators and possibly small amounts of solvent are introduced continuously by means of appropriate metering devices 2 and backmixed in the process space. This is indicated by the dotted circle 10. The mixing kneader 1 does not have ideal backmixing, but in practice has a behavior which corresponds to that of a stirred tank cascade having 2 to 5, typically having 3 to 4, stirred tanks connected in series. This behavior coincides well with the number/subdivision of chambers which are formed by the disks/disk elements/disk segments 13 mounted on the shaft(s) 12. Static kneading counter-elements 11 in the case of single-shaft mixing kneaders, or the dynamic kneading bar elements 13 mounted on the disks, intermesh and cause intensive mixing and kneading of viscous materials. This term “chamber” is not understood to mean a closed space, but open cells in communication with one another.

The viscosity of the reaction mixture in the mixing kneader 1 is adjusted by the selection of the reaction system, the catalyst concentration, the throughput, the temperature, the pressure, etc., such that the product is degassed/demonomerized/devolatilized directly in a downstream second mixing kneader/extruder/flash pot 4, or the unreacted monomer can be reacted to completion in a downstream apparatus, for example a maturing tank.

The processing temperature and operating pressure in the mixing kneader are preferably selected such that the product viscosities established allow limited mechanical introduction of heat and/or such that the monomer excess or the solvent content is within the boiling range. The corresponding temperature range depends on the polymer itself.

With this process just described, it is possible to remove the heat of reaction and the dissipated kneading energy by the evaporation of the solvent/monomer. This vapor is condensed in a reflux condenser 5 directly on top of the mixing kneader 1, and returned to the reaction mixture. Several reflux condensers can be distributed over the length of the mixing kneader 1. More particularly, it is conceivable that each chamber is assigned a reflux condenser. The condensation can incidentally also be implemented externally, in which case the condensate can be metered back into the reaction mixture in a controlled manner at particular sites, preferably in the entry and middle region of the mixing kneader with different nozzles. By virtue of the small L/D (length/diameter) ratio of preferably 0.5 to 3.5 of the mixing kneader 1, the returning condensate, even without controlled recycling, is mixed back in optimally and homogeneously in the reactor, which constitutes a great problem in backmixing extruders used to date with a large L/D ratio.

The backmixed mixing kneader 1 can be run under reduced pressure, at atmospheric or underpressure. For polymerization systems which are operated with reduced pressure, a valve 23 is opened and the line 24 is attached to a vacuum pump. In this way, leakage gas streams and inert gas blankets are drawn off, but the monomer condenses virtually fully in the reflux condenser 5 and is returned to the reaction mixture in the mixing kneader 1. For polymerization systems which are operated at atmospheric, the valve 23 is open and the line is left under these atmospheric conditions.

For polymerization systems which are operated with pressures higher than ambient pressure, preference is given to using an inert gas (e.g. nitrogen) to regulate the system pressure to a particular value, which is accomplished by means of a valve 14. The valve 23 is closed in this case.

### Example

In the case of PLA, the optimal processing temperature range for the polymerization reaction is 175-190° C., the specific kneader shaft torque being between 20-45 Nm/liter of total process space volume at a fill level of approx. 70% according to the desired molar mass of the PLA and according to the product temperature profile. The operating pressure can be adjusted correspondingly freely, such that the evaporating action of the lactide monomer (evaporative cooling with reflux condensation) takes account of the higher or lower mechanical kneading heat input.

The reflux condenser is preferably heated with a heating medium at 110-140°, at temperatures which allow maximum condensation of the lactide vapors at the exchange surfaces, but which are still significantly above the solidification temperature (or melting temperature) of the lactide monomer and hence guarantee liquid reflux.

The reaction product/the viscous material is drawn off at the discharge end of the mixing kneader by means of an integrated discharge device 3, known as a discharge twin screw with forced conveying, which may be positioned vertically, but also horizontally. This in turn feeds a gear pump connected directly downstream, the speed of which can be regulated such that the fill level and hence the product residence time in the mixing kneader remain constant. A constantly regulated mixing kneader fill level is, in addition to the constant continuous throughput predefined by the metering units, an absolute necessity to be able to ensure process stability and homogeneous product properties. The regulation parameter used for the speed regulation of the gear pump is a suitable measuring device 8 for the fill level, for example the torque at the mixing kneader shaft, the weight of the mixing kneader product contents (holdup), the radiometric fill level measurement, etc. The product is supplied to the gear pump by means of regulation of the speed of the twin screw while keeping the feed pressure constant.

The gear pump 17 is followed downstream by a perforated plate or die plate 18, by means of which product from the discharge device 3 can be introduced in the manner of spaghetti into the second mixing kneader/extruder/flash pot 4. An arrow 20 between gear pump 17 and perforated plate or die plate 18 indicates that, in this region, it is also possible to add gaseous or liquid stripping media for subsequent promotion of degassing, or additives, for example reaction stoppers, stabilizers, etc. Stripping media cause, on entry into the second mixing kneader/extruder/flash pot, bursting or breaking open of the product surfaces and hence improved mass transfer.

The second mixing kneader/extruder 4 is assigned a motor M, by means of which one or more stirrer shaft(s) 21 with stirring/kneading elements 22 is/are driven. The stirrer shaft geometry is configured so as to result in plug flow with a narrow residence time spectrum (corresponding to 10-16 stirred tanks connected in series), or else more or less marked backmixing (corresponding to 2 to 5 stirred tanks connected in series). In addition, one or more vapor dome(s) 19 are placed on top of the mixing kneader/extruder 4, through which the products to be evaporated (monomers, solvents, stripping media, etc.) can be drawn off. Analogously to the mixing kneader 1, the mixing kneader/extruder 4 is followed by a further discharge screw 25 and a gear pump 26, which can provide the necessary pressure for the granulation of the end product.

1. A process for treating viscous products, especially for performing polymerization processes, especially for homo- or copolymerizing biopolymers, by adding monomer(s) and/or catalysts and/or initiators to a backmixed mixing kneader (1), especially having a length/diameter ratio of 0.5-3.5, especially corresponding to the behavior of a stirred tank cascade of 2-5 stirred tanks connected in series, supplying heat to the product and backmixing with already reacted product, and removing the reacted product from the mixing kneader (1), characterized in that
the product is heated in the mixing kneader (1) up to its optimal processing temperature or boiling temperature or sublimation temperature, portions of the product are evaporated, and hence exothermicity of the product and excessive mechanical introduction of heat is absorbed by evaporative cooling.

2. The process as claimed in claim 1, characterized in that the evaporated portions of the product, especially in the case of polymerization of biopolymers such as PLA, PHA, PHB, etc., are fully or at least partly condensed and recycled as condensate back into the mixing kneader to cool the remaining product.

3. The process as claimed in claim 2, characterized in that the recycling into the mixing kneader (1) is effected at the site at which the main evaporation is also effected.

4. The process as claimed in claim 1, characterized in that the processing temperature or boiling temperature or sublimation temperature is set to a predetermined value by altering the pressure in the mixing kneader (1).

5. The process as claimed in claim 1, characterized in that a vacuum is built up to draw off vapors in the mixing kneader (1).

6. A process for treating viscous products, especially for performing polymerization processes, especially for homo- or copolymerizing biopolymers, by adding monomer(s) and/or catalysts and/or initiators to a backmixed mixing kneader (1), especially having a length/diameter ratio of 0.5-3.5, backmixing them with already reacted product therein, and removing the reacted product from the mixing kneader (1) characterized in that the backmixing is effected until a predetermined viscosity of the product is attained and this viscosity is maintained by continuously adding further monomer and/or catalysts and/or initiators.

7. The process as claimed in claim 6, characterized in that the product is evaporated by introduction of energy consisting of mechanical kneading energy and/or heat transfer via the contact with kneader heat exchange surfaces up to just above the point of collapse of the evaporation rate, and new low-viscosity product solution is mixed continuously into the viscous product bed thus pre-evaporated, such that the evaporation rate remains above the point of collapse.

8. The process as claimed in claim 7, characterized in that any kneading energy is influenced by variation of the speed and/or of the fill level of the mixing kneader (1).

9. The process as claimed in claim 6, characterized in that the product is backmixed continuously in the mixing kneader (1).

10. The process as claimed in claim 6, characterized in that the product is discharged continuously from the mixing kneader (1) and introduced into a second mixing kneader or extruder or flash pot (4).

11. The process as claimed in claim 10, characterized in that the product is heated on discharge from the mixing kneader (1) before it arrives in the second mixing kneader or extruder or flash pot (4).

12. The process as claimed in claim 11, characterized in that the product is subjected to plug flow or backmixing in the second mixing kneader or extruder (4).

13. The process as claimed in claim 12, characterized in that the product is subjected to substantial surface renewal and good product temperature control in the mixing kneader or extruder (4).

14. An apparatus for treating viscous products, especially for performing polymerization processes, especially for homo- or copolymerizing biopolymers, comprising a continuously backmixed mixing kneader (1), especially having a length/diameter ratio of 0.5-3.5, for accommodating monomer(s) and/or catalysts and/or initiators which is/are backmixable with already reacted product, and a discharge device (3) by which the reacted product can be removed from the mixing kneader (1), characterized in that the mixing kneader (1) is divided into two to five, preferably into three to four, chambers in which the backmixing is effected.

15. An apparatus for treating viscous products, especially for performing polymerization processes, especially for homo- or copolymerizing biopolymers, comprising a continuously backmixed mixing kneader (1), especially having a length/diameter ratio of 0.5-3.5, for accommodating monomer(s) and/or catalysts and/or initiators which is/are backmixable with already reacted product, and a discharge device (3) by which the reacted product can be removed from the mixing kneader (1), characterized in that the discharge device (3) is followed by a further mixing kneader or extruder or flash pot (4), in which case a comminution device (18) for the product to be transferred is inserted between discharge apparatus (3) and extruder (4).

16. The apparatus as claimed in claim 15, characterized in that the comminution apparatus is a perforated plate (18).

17. The apparatus as claimed in claim 15, characterized in that a pump, especially a gear pump (17), is connected upstream of the comminution device (18).

18. The apparatus as claimed in claim 17, characterized in that a measuring device for continuous control of the constant product fill level in the mixing kneader is connected upstream of the gear pump (17).

19. The apparatus as claimed in claim 18, characterized in that the gear pump (17) is connected to a fill level meter (8) in the first mixing kneader (1).

20. The apparatus as claimed in claim 19, characterized in that there is the possibility of adding stripping media or additives downstream of the gear pump (17) and upstream of the comminution device (18).

21. The apparatus as claimed in claim 20, characterized in that the stripping media is water or nitrogen.
